(19) United States
(12) Patent Application Publication
(10) Pub. No.: US 2008/0096084 A1
(43) Pub. Date: Apr. 24, 2008

(54) FUEL CELL STRUCTURE

(76) Inventors: HSI-MING SHU, Taipei (TW); Tsang-Ming Chang, Taipei (TW); Wei-Li Huang, Taipei (TW)

Correspondence Address: G. LINK CO., LTD., 3550 BELL ROAD, MINOOKA, IL, 60447, US

(21) Appl. No.: 11/874,088

(22) Filed: Oct. 17, 2007

(30) Foreign Application Priority Data
Oct. 18, 2006 (TW) 095138302

(51) Int. Cl. H01M 8/02

(52) U.S. Cl. 429/34

(57) ABSTRACT

The present invention discloses a fuel cell structure, which comprises a membrane electrode assembly pallet, a cathode channel pallet and an anode channel pallet. These membrane electrode assemblies are sandwiched and configured between the upper frame pallet and the lower frame pallet, and the material for the two frame pallets are made of the material melted with the supersonic vibration frequency welding means. The cathode channel pallet is a pallet-body structure and bonded with the upper frame pallet of the membrane electrode assembly pallet. The anode channel pallet is a pallet-body structure and bonded with the lower frame pallet of the membrane electrode assembly pallet. The material for the two channel pallets are made of the material melted with the supersonic vibration frequency welding means. The cathode channel pallet, the membrane electrode assembly pallet, and the anode channel pallet are welded and bonded as a single piece structure by the super sonic vibration frequency welding means.

### FIELD OF THE INVENTION

The present invention relates to a fuel cell structure, and particularly a structure using the supersonic welding means to fix the membrane electrode assembly pallet between the cathode channel pallet and the anode channel pallet during the assembly of the membrane electrode assembly pallet, the cathode channel pallet and the anode channel pallet.

### BACKGROUND OF THE INVENTION

The fuel cell is a high performance energy conversion device, which could supply the fuel at the anode and supply the oxidant at the cathode, and convert the chemical energy of the fuel into electric energy through the electrochemical reaction. The using fuel could be hydrogen or natural gas, methanol and gasoline after re-composition. The oxidant could be oxygen or air. If using hydrogen as the fuel, the produce of the fuel cell is water, electric energy, and thermal energy. Thus, the fuel cell could be treated as a power generation device with low pollution, and even no pollution.

The conventional fuel cell structure employs the adhesives, such as PP glue, to adhere and fix the membrane electrode assembly (MEA) layer between the cathode channel pallet and the anode channel pallet. Usually, this kind of fuel cell employs the process of printed circuit board to manufacture the fuel cell. Because the process of printed circuit board needs to purchase expensive equipment, the manufacturing cost for the fuel cell would be rather high.

Another type of conventional fuel cell structure employs the screwing means, such as the screwing of bolts and nuts, to screw and fix the membrane electrode assembly layer between the cathode channel pallet and the anode channel pallet. Generally speaking, the fuel cell assembled with the screwing means would have very large overall volume, which is not suitable for carrying.

In view of the existed defects in manufacturing and usage of the conventional fuel cell, the inventor of the present invention worked hard for improvement, and invented a fuel cell structure to solve the above-mentioned problems.

### SUMMARY OF THE INVENTION

The object of the present invention is to provide a fuel cell structure, which could employ the supersonic welding means to fix the membrane electrode assembly pallet on the cathode channel pallet and the anode channel pallet.

To this end, the present invention comprises: a membrane electrode assembly pallet, a cathode channel pallet and an anode channel pallet. The membrane electrode assembly pallet comprises at least one membrane electrode assembly, an upper frame pallet and a lower frame pallet, and the membrane electrode assemblies are sandwiched and configured between the upper frame pallet and the lower frame pallet, and the material for the upper frame pallet and the lower frame pallet is made of the material melted with the supersonic vibration frequency welding means. The cathode channel pallet is a pallet-body structure, and bonded with the upper frame pallet of the membrane electrode assembly pallet. The anode channel pallet is a pallet-body structure, and bonded with the lower frame pallet of the membrane electrode assembly pallet. The material for the cathode channel pallet body and the anode channel pallet body is made of the material melted with the supersonic vibration frequency welding means. The cathode channel pallet, the membrane electrode assembly pallet, and the anode channel pallet are welded and bonded as a single piece structure by sequentially laminating and stacking the cathode channel pallet, the membrane electrode assembly pallet, and the anode channel pallet from top to bottom and by the supersonic vibration frequency welding means.

### BRIEF DESCRIPTION OF THE DRAWINGS

The structure, features and effects according to the present invention could be further recognized and understood with the detailed description of the preferred embodiments and figures as follows, wherein:

FIG. 1 is a structural diagram for a fuel cell structure of a preferred embodiment according to the present invention;

FIG. 2A is a three-dimensional exploded diagram of the fuel cell structure according to the present invention in FIG. 1;

FIG. 2B is a three-dimensional exploded diagram in another view angle of the fuel cell structure according to the present invention of FIG. 1;

FIG. 3 is a three-dimensional exploded diagram of the preferred embodiment according to the present invention;

FIG. 4 is a three-dimensional diagram for a cathode channel pallet of the preferred embodiment according to the present invention;

FIG. 5 is a three-dimensional diagram for the cathode channel pallet configured with current collection sheet according to the present invention of FIG. 4;

FIG. 6 is a three-dimensional diagram for an anode channel pallet of the preferred embodiment according to the present invention;

FIG. 7 is a three-dimensional diagram for the anode channel pallet configured with current collection sheet according to the present invention of FIG. 6; and

FIG. 8 is a diagram for the bonding area of the fuel cell structure applied with supersonic welding means according to the present invention.

### DETAILED DESCRIPTION OF THE INVENTION

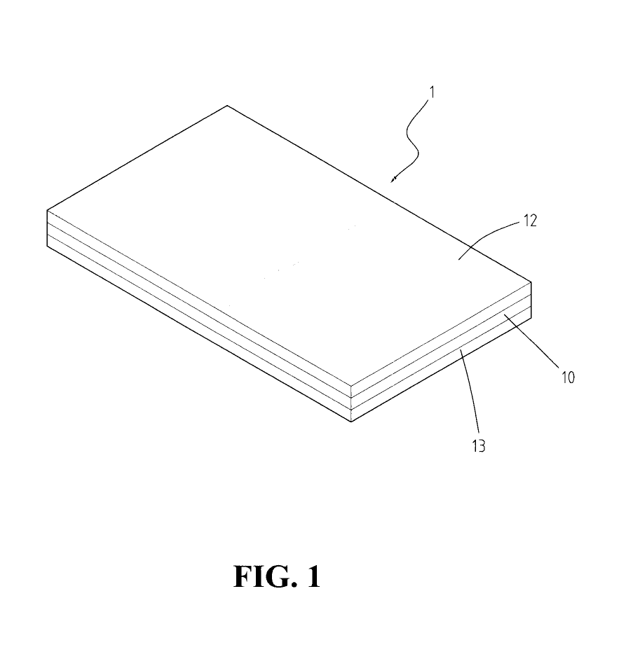

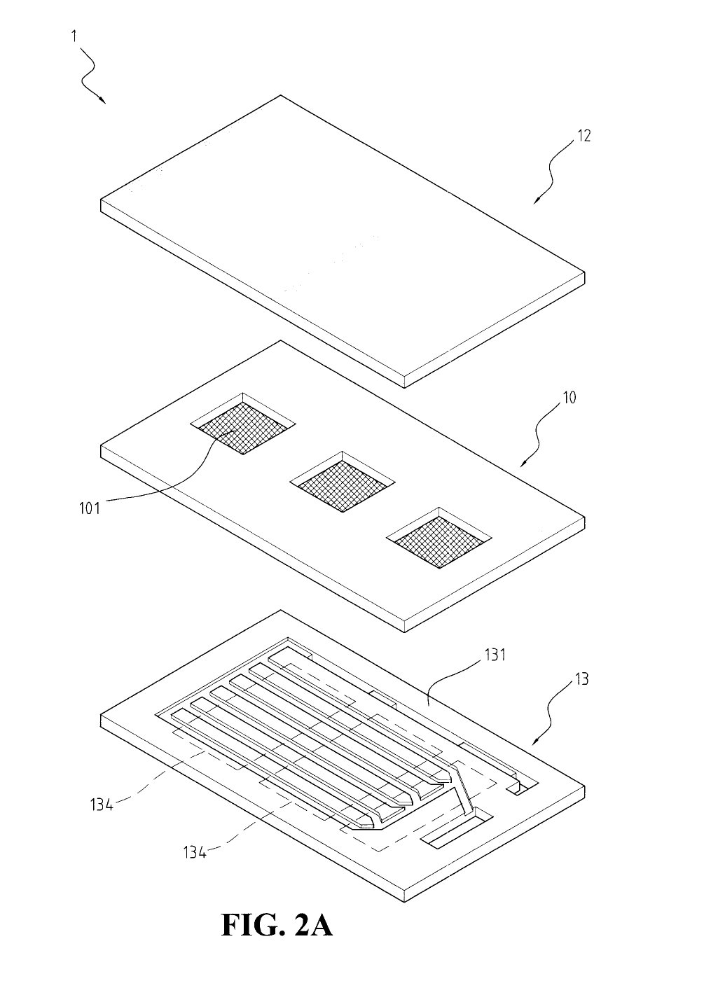

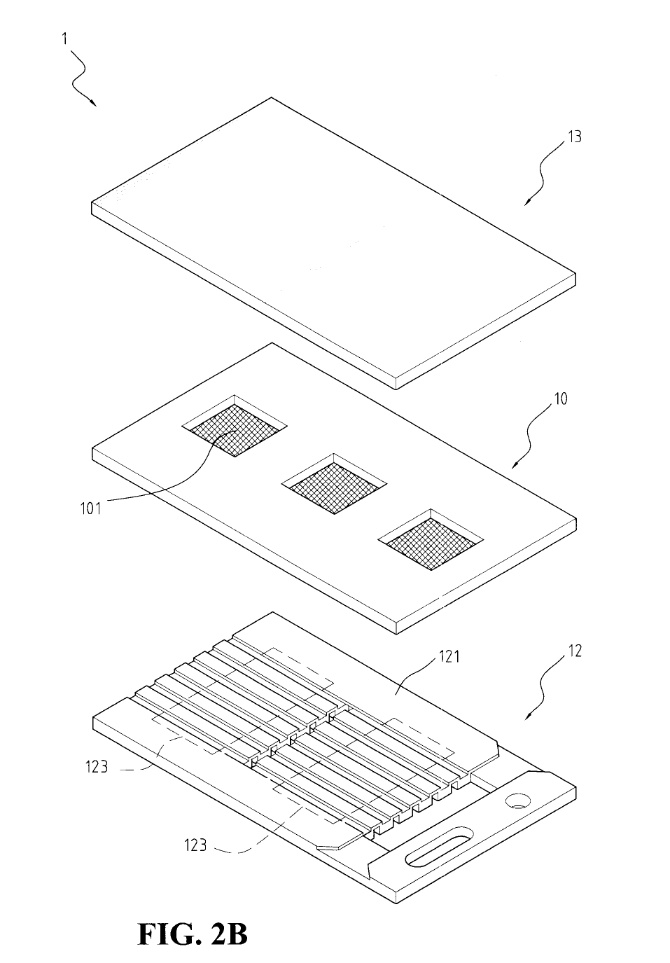

Please refer to FIG. 1, FIG. 2A and 2B. The fuel cell structure 1 according to the present invention comprises a membrane electrode assembly pallet 10, a cathode channel pallet 12 and an anode channel pallet 13. During the assembly, the cathode channel pallet 12, the membrane electrode assembly pallet 10 and the anode channel pallet 13 are sequentially laminated and stacked from top to bottom, and employ the supersonic vibration frequency welding means to weld and bond the cathode channel pallet 12, the membrane electrode assembly pallet 10 and the anode channel pallet 13 as a single piece structure, and these components are described in details as follows, respectively.

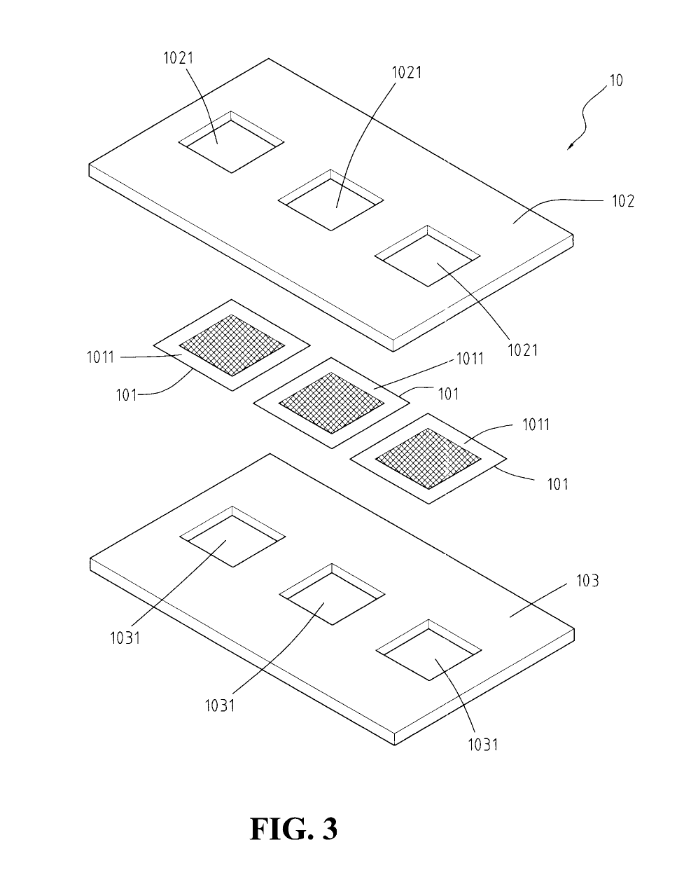

Please refer to FIG. 3. The membrane electrode assembly pallet 10 comprises at least one membrane electrode assembly 101, an upper frame pallet 102, a lower frame pallet 103, and these membrane electrode assemblies 101 are sandwiched and configured between the upper frame pallet 102 and the lower frame pallet 103, and the material for the upper frame pallet 102 and the lower frame pallet 103 is made of the material melted with the supersonic vibration frequency welding means.

The upper frame pallet 102 is configured with at least one first opening 1021, and the lower frame pallet 103 is also configured with at least one second opening 1031, and these first openings 1021 and these second openings 1031 are corresponded in opposite. The shapes of the first openings 1021 and the second openings 1031 could be configured as quadrilateral, but not limited to.

The membrane electrode assembly 101 could directly employ the conventional membrane electrode assembly, such as the membrane electrode assembly of direct methanol fuel cell or the membrane electrode assembly containing proton exchange membrane. The present invention could directly employ the manufacturing techniques relating to the conventional membrane electrode assembly that the upper and lower surfaces of the proton exchange membrane 1011 could be formed with the anode and the cathode respectively to obtain the membrane electrode assembly 101. In the mean time, the area of the proton exchange membrane 1011 could be approximately larger than the area of the first opening 1021 and the second opening 103 1. The bonding means for bonding the upper frame pallet 102, these membrane electrode assemblies 101 and the lower frame pallet 103 as a single piece structure could employ the adhesion means with adhesives, or employ the supersonic welding means.

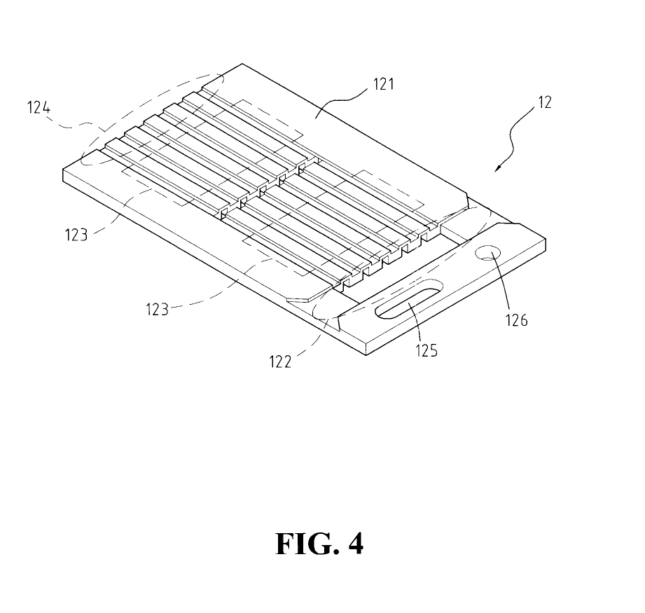

Please refer to FIG. 4. The cathode channel pallet 12 comprises a pallet body 121, an inlet channel structure 122, at least one slot body 123, an outlet channel structure 124, a first hollow area 125, and a second hollow area 126.

The material for the pallet body 121 is made of a material melted with supersonic welding means, and the material could be selected from one of PS, SPS, PES, ABS, PC, PP, PPSU, PVO and PSU.

If the inlet channel structure 122, these tank bodies 123, the outlet channel structure 124, the first hollow area 125, the second hollow area 126 are only configured on the upper surface of the pallet body 121, it would be formed as a single-side cathode channel pallet 12. On the other hand, if the inlet channel structure 122, these tank bodies 123, the outlet channel structure 124, the first hollow area 125, the second hollow area 126 are all configured on the upper surface and the lower surface of the pallet body 121, it would be formed as a double-side cathode channel pallet 12.

The inlet channel structure 122 is connected with these tank bodies 123. The inlet area of the inlet channel structure is dug downwardly from the surface of the pallet body 121 as a recess structure; at the same time, the area adjacent to the inlet channel structure 122 and these tank bodies 123 employs a hollow structure, that is, the surface of the pallet body 121 occupied by the adjacent areas has been dug out.

These tank bodies 123 are arranged and configured on the pallet body 121, and the configured position for each slot body 123 is corresponding to the configured position of the cathode of each membrane electrode assembly 101. The means for implementing these tank bodies 123 is to dig downwardly the surface of the pallet body 121 as a plurality of parallel slots.

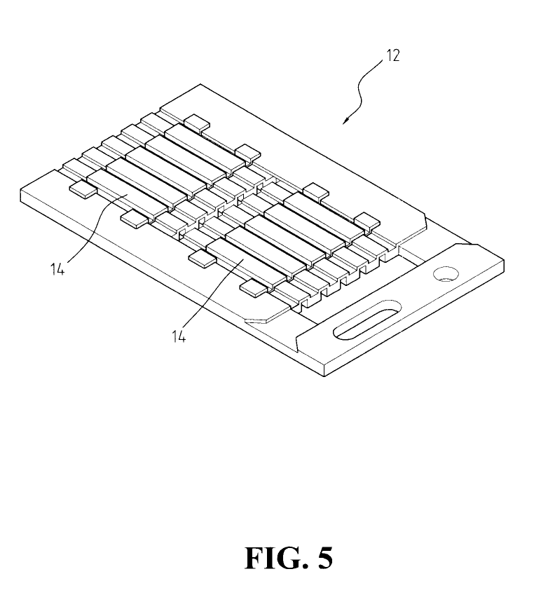

In order for these slot bodies 123 further providing the current collection function, the surface of each slot body 123 could be coated with a conductive layer (not shown), such as coating with a layer of gold-containing conductive painting; or, configuring an current collection sheet 14 on the surface of each slot body 123. Please refer to FIG. 5.

The external cathode fuel, such as air, is flowing into inside of the cathode channel pallet 12 from the inlet channel structure 122; then, the cathode fuel is guided and flowing into each slot body 123; finally, flowing into the cathode of each membrane electrode assembly 101. Furthermore, the cathode product, such as water, generated after the electrochemical reaction at the cathode of each membrane electrode assembly 101 would flow into each slot body 123; finally, the cathode product and the remaining cathode fuel would flow toward the outlet channel structure 124.

The outlet channel structure 124 is configured on the pallet body 121, and connected to these slot bodies 123. The outlet channel structure 124 could employ a plurality of parallel slots, and these slots are connected to the slot body 123. The cathode product and the remaining cathode fuel would flow through the outlet channel structure 124, and flow outside the cathode channel pallet 12.

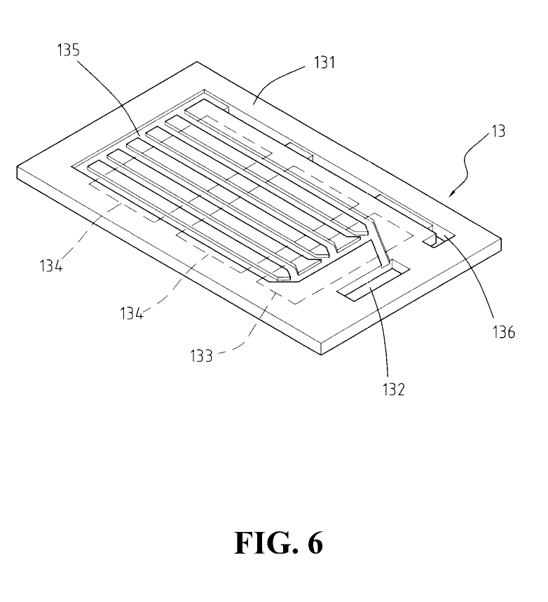

Please refer to FIG. 6. The anode channel pallet 13 according to the present invention comprises: a pallet body 131, a bypass portion 132, an inlet channel structure 133, at least one slot body 134, an outlet channel structure 135, and an outlet hole 136, which are described in details as follows.

The material for the pallet body 132 is made of the material as the cathode channel pallet 12, which would not be described again.

If the bypass portion 132, the inlet channel structure 133, the slot bodies 134, the outlet channel structure 135 and the outlet hole 136 are only configured on the upper surface of the pallet body 131, it would be formed as a single-side anode channel pallet 13. On the other hand, if the bypass portion 132, the inlet channel structure 133, the slot bodies 134, the outlet channel structure 135 and the outlet hole 136 are configured on both the upper surface and the lower surface of the pallet body 131, it would be formed as a double-side anode channel pallet 13.

The bypass portion 132 is configured on one side of the pallet body 131. A small portion of the area of the pallet body 131 is hollowed to become a hollow area and forms a bypass portion 132. The hollow area of the bypass portion 132 could accommodate the flow-in anode fuel, such as methanol aqueous solution. After the flow-in anode fuel filled up the bypass portion 132, the anode fuel would flow toward the inlet channel structure 133.

The inlet channel structure 133 is connected between the bypass portion 132 and these slot bodies 134. The means for implementing the inlet channel structure 133 is to dig downwardly from the surface of the pallet body 131 as a plurality of slots, and these ends along the same direction as the plurality of slots are connected to the bypass portion 132. And, the other ends of the plurality of slots in another direction are connected with the slot bodies. The inlet channel structure 133 employs the design of uniform flowing volume, so that the anode fuel from the bypass portion 132 will flow through the plurality of slots, and, finally, the flow-out volume of the anode fuel flowing from each end connected to the slot body 134 is exhibited as uniform flowing volume.

The slot bodies 134 are arranged and configured on the pallet body 131, and the configured position of each slot body 134 is corresponding to the configured position of the anode of each membrane electrode assembly 101. The means for implementing the slot bodies 134 is to dig downwardly from the surface of the pallet body 131 as a plurality of parallel slots. The anode fuel from the inlet channel structure 133 is flowing into each slot body 134; then, flowing into the anode of each membrane electrode assembly 101; and, the anode product generated after the electrochemical reaction at the anode of each membrane electrode assembly 101 would flow into each slot body 134; finally, the anode product and the remaining anode fuel would flow toward the outlet channel structure 135.

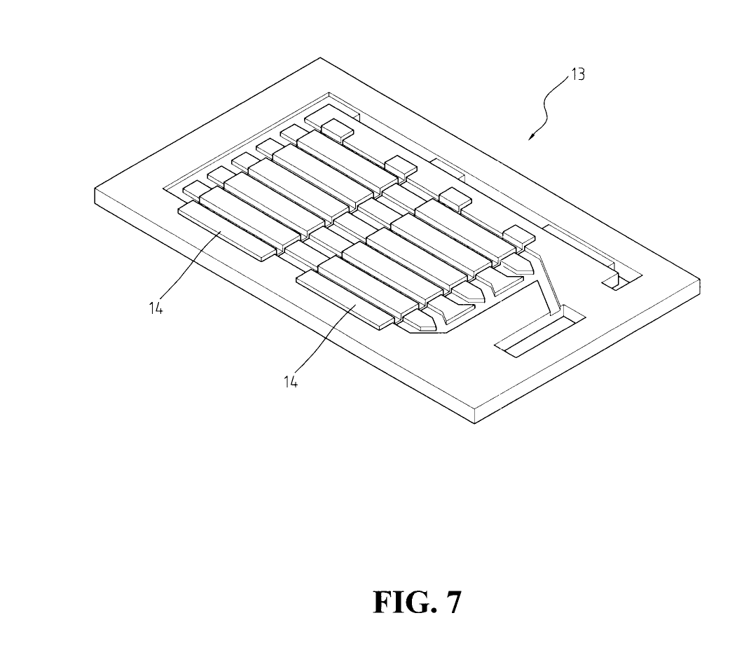

In order for these slot bodies 134 further providing the current collection function, the surface of each slot body 134 is coated with a conductive layer (not shown), such as coating with a layer of gold-containing conductive painting; or, configuring an current collection sheet 14 on the surface of each slot body 134. Please refer to FIG. 7.

The outlet channel structure 135 is connected between the slot bodies 134 and the outlet hole 136. The design of a portion of inlet channel structure 133 immediately adjacent to the slot body 134 employs the slot structure, and the means for the slot structure is to dig downwardly from the surface of the pallet body 131 as one or more slots. The design of a portion of outlet channel structure 135 immediately adjacent to the outlet hole 136 employs the strip-hole structure, and the means for the strip-hole structure is to dig downwardly from the surface of the pallet body 131 as one or more hollow strip-like areas.

The purpose of the design using the strip-hole structure for a portion of the outlet channel structure 135 is to enlarge the outlet channel for reducing the internal pressure of the anode channel pallet 13. Therefore, the anode product, such as CO₂, or bubbles could be smoothly exhausted to the outlet hole 136 without staying in the outlet channel structure 135.

The outlet hole 136 is configured on one side of the pallet body 131 and connected to the outlet channel structure 135. The means for implementing the outlet hole 136 is to dig a small portion of the area of the pallet body 131 as a hollow area. The configured position for the outlet hole 136 could be selected to be on the same side as the bypass portion 132 on the pallet body 131. The anode product and the remaining anode fuel from the outlet channel structure 135 could flow out on the anode channel pallet 13 from the outlet hole 136.

The material for the current collection sheet 14 is a kind of conductive material, and an anti-erosion/or anti-acid resistant material, such as selecting one from stainless steel (SUS316) sheet, golden foil, titanium metal, graphite material, carbon metal composite material, metal alloy sheet and low resistance polymer conductive sheet. The means for the current collection sheet 14 is determined followed by the structure of the slot bodies 123, 134.

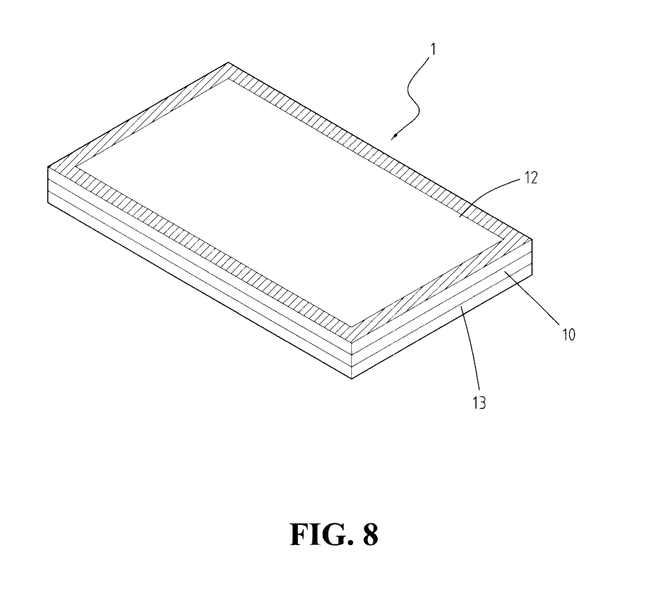

The supersonic welding means used in the present invention could directly employ the conventional supersonic welding means, such as employing the supersonic with vibration frequency from 10K Hz to 20K Hz, and the time period of 0.1 to 30 seconds, so that the cathode channel pallet 12 could be welded and bonded with the upper frame pallet 102 of the membrane electrode assembly pallet 10, and the anode channel pallet 13 could be welded and bonded with the lower frame pallet 103 of the membrane electrode assembly pallet 10, and bonding as the fuel cell with single-piece structure. The supersonic will be applied onto the area bonded with the cathode channel pallet 12 and the upper frame pallet 102, and the area bonded with the anode channel pallet 13 and the lower frame pallet 103. The location for the two bonded areas could be realized by the location of the shaded area. Please refer to FIG. 8.

The present invention employs the material for the membrane electrode assembly pallet, the cathode channel pallet and the anode channel pallet melted with the supersonic welding means, so as to employs the supersonic welding means to bond and fix the material of the membrane electrode assembly pallet, the cathode channel pallet and the anode channel pallet. The fuel cell structure according to the present invention is actually a novel and an innovative method, and the feature is obviously the advantage of the present invention.

The above description is only the preferred embodiment according to the present invention, which could not be used to limit the application range of the present invention, and the skilled in the art could obviously make changes and modification, which should be treated without departing from the substantial content of the present invention.

What is claimed is:

1. A fuel cell structure, which comprises:
a membrane electrode assembly pallet, which includes at least one membrane electrode assembly, an upper frame pallet, a lower frame pallet, in which the membrane electrode assemblies are sandwiched and configured between the upper frame pallet and the lower frame pallet, and the material for the upper frame pallet and the lower frame pallet is made of the material melted with the supersonic vibration frequency welding means;
a cathode channel pallet, which is a pallet-body structure and bonded with the upper frame pallet of the membrane electrode assembly pallet, in which the material for the pallet body of the cathode channel pallet is made of the material melted with the supersonic vibration frequency welding means;
an anode channel pallet, which is a pallet-body structure and bonded with the lower frame pallet of the membrane electrode assembly pallet, in which the material for the pallet body of the anode channel pallet is made of the material melted with the supersonic vibration frequency welding means;
wherein, the cathode channel pallet, the membrane electrode assembly pallets, and the anode channel pallet are sequentially laminated and stacked from top to bottom, and employing the supersonic vibration frequency welding means to weld and bond the cathode channel pallet, the membrane electrode assembly pallets, the anode channel pallet as a single-piece structure.

2. The fuel cell structure according to claim 1, wherein the membrane electrode assembly pallet comprises:
the upper frame pallet, which is provided with at least one first opening;
the lower frame pallet, which is provided with at least one second opening, and the second openings are corresponding to the first openings; and,
the membrane electrode assemblies are sandwiched between the first openings and the second openings correspondingly.

3. The fuel cell structure according to claim 1, wherein the cathode channel pallet comprises a channel structure, which is configured on the pallet body, in which the channel structure is provided with at least one slot body, and the configured positions for the slot bodies are corresponding to the configured positions of electrodes of each membrane electrode assembly, and the cathode channel pallet is welded and bonded with the upper frame pallet of the membrane electrode pallet with supersonic vibration frequency welding means.

4. The fuel cell structure according to claim 1, wherein the anode channel pallet comprises a channel structure, which is configured on the pallet body, in which the channel structure is provided with at least one slot body, and the configured positions for the slot bodies are corresponding to the configured positions of electrodes of each membrane electrode assembly, and the anode channel pallet is welded and bonded with the lower frame pallet of the membrane electrode pallet with supersonic vibration frequency welding means.

5. The fuel cell structure according to claim 3, further comprises at least one current collection sheet, which are configured in the slot bodies of the cathode channel pallet, respectively.

6. The fuel cell structure according to claim 4, further comprises at least one current collection sheet, which are configured in the slot bodies of the anode channel pallet, respectively.

7. The fuel cell structure according to claim 3, wherein the surface of the slot bodies of the cathode channel pallet is further coated with a conductive layer.

8. The fuel cell structure according to claim 4, wherein the surface of the slot bodies of the cathode channel pallet is further coated with a conductive layer.

9. The fuel cell structure according to claim 1, wherein the material for the upper frame pallet is one of PS, SPS, PES, ABS, PC, PP, PPSU, PVO and PSU.

10. The fuel cell structure according to claim 1, wherein the material for the lower frame pallet is one of PS, SPS, PES, ABS, PC, PP, PPSU, PVO and PSU.

11. The fuel cell structure according to claim 1, wherein the material for the pallet body of the cathode channel pallet is one of PS, SPS, PES, ABS, PC, PP, PPSU, PVO and PSU.

12. The fuel cell structure according to claim 1, wherein the material for the pallet body of the anode channel pallet is one of PS, SPS, PES, ABS, PC, PP, PPSU, PVO and PSU.

13. The fuel cell structure according to claim 3, wherein the slot body of the cathode channel pallet is formed with a plurality of parallel slots.

14. The fuel cell structure according to claim 4, wherein the slot body of the anode channel pallet is formed with a plurality of parallel slots.

15. The fuel cell structure according to claim 5, wherein the current collection sheet is selected from one of stainless steel (SUS316), golden foil, titanium metal, graphite material, carbon metal composite material, metal alloy sheet, and low resistance polymer current collection sheet.

16. The fuel cell structure according to claim 6, wherein the current collection sheet is selected from one of stainless steel (SUS316), golden foil, titanium metal, graphite material, carbon metal composite material, metal alloy sheet, and low resistance polymer current collection sheet.

17. The fuel cell structure according to claim 1, wherein the cathode channel pallet is a single-side cathode channel pallet.

18. The fuel cell structure according to claim 1, wherein the cathode channel pallet is a double-side cathode channel pallet.

19. The fuel cell structure according to claim 1, wherein the anode channel pallet is a single-side cathode channel pallet.

20. The fuel cell structure according to claim 1, wherein the anode channel pallet is a double-side anode channel pallet.
